(19) United States
(12) Patent Application Publication
(10) Pub. No.: US 2025/0021876 A1
(43) Pub. Date: Jan. 16, 2025

(54) INFORMATION PROCESSING METHOD

(71) Applicant: TOYOTA JIDOSHA KABUSHIKI KAISHA, Toyota-shi (JP)

(72) Inventors: Lei ZHONG, Tokyo (JP); Xiao SHAO, Kawasaki-shi (JP); Jing MA, Yokohama-shi (JP)

(73) Assignee: TOYOTA JIDOSHA KABUSHIKI KAISHA, Toyota-shi (JP)

(21) Appl. No.: 18/756,255

(22) Filed: Jun. 27, 2024

(30) Foreign Application Priority Data
Jul. 10, 2023 (JP) 2023-113006

(51) Int. Cl. G06N 20/00

(52) U.S. Cl. CPC G06N 20/00

(57) ABSTRACT

Each of a plurality of information processing apparatuses mounted on different mobile bodies performs machine learning using local data, and generates a local model. Each of the plurality of information processing apparatuses exchanges an evaluation value with another information processing apparatus mounted on each of the other mobile bodies by proximity communication. Then, among the information processing apparatuses whose evaluation value is equal to or greater than a predetermined value, the number of information processing apparatuses whose upper limit is the first threshold value transmits local model information indicating the generated local model to the server device.

### CROSS-REFERENCE TO RELATED APPLICATION

This application claims priority to Japanese Patent Application No. 2023-113006 filed on Jul. 10, 2023, incorporated herein by reference in its entirety.

### BACKGROUND

### 1. Technical Field

The present disclosure relates to a federated learning technique.

### 2. Description of Related Art

Federated learning has been proposed as a method of machine learning. The federated learning is a method of performing machine learning in a distributed manner without aggregating learning data at one location. In this regard, U.S. Patent Application Publication No. 2020/0242514, for example, discloses an example of a procedure for performing federated learning between a server device and client devices.

### SUMMARY

An object of the present disclosure is to efficiently perform federated learning between a server device and a plurality of information processing apparatuses.

An aspect of an embodiment of the present disclosure provides an information processing method including: each of a plurality of information processing apparatuses mounted on different mobile bodies generating a local model by performing machine learning using local data; each of the information processing apparatuses receiving a first threshold value and an evaluation index from a server device; each of the information processing apparatuses calculating an evaluation value according to the evaluation index; each of the information processing apparatuses exchanging the evaluation value with another information processing apparatus mounted on each of one or more other mobile bodies existing within a predetermined range through near field communication; and a number of information processing apparatuses transmitting local model information that indicates the generated local model to the server device, the information processing apparatuses being mounted on respective ones of one or more mobile bodies existing within the predetermined range and having calculated an evaluation value that is equal to or more than a predetermined value, and the number of the information processing apparatuses being up to the first threshold value.

Other aspects provide a program causing a computer to execute the above method and a computer-readable storage medium storing the program in a non-transitory manner.

According to the present disclosure, it is possible to efficiently perform federated learning between a server device and a plurality of information processing apparatuses.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a federated learning system according to a first embodiment;

FIG. 2 is a diagram illustrating an example of a configuration of the server device 2;

FIG. 3 is a diagram illustrating an example of a configuration of the in-vehicle device 10;

FIG. 4 illustrates the flow of data between devices;

FIG. 5 is a flowchart illustrating a flow of a process between apparatuses; and

FIG. 6 is a flow chart detailing S13 process.

### DETAILED DESCRIPTION OF EMBODIMENTS

Consider a case where a machine learning model is generated by federation learning. In federation learning, a plurality of client devices each generate a local model using local data, and a server device collects and integrates the local model. All client devices that can participate may participate in the federation learning. However, when all client devices (e.g., all vehicles traveling on a road) participate in the federation learning, the amount of data may increase and the efficiency may deteriorate. Moreover, it is not always possible to generate a highly accurate trained model. Therefore, there is a method in which the server device selects a client device participating in the federation learning.

As a simple method of selecting a client device, there is a method of randomly selecting a client device. However, in this method, since the attribute of the client device is unknown, a local model suitable for model update is not necessarily obtained from the selected client device. Therefore, model updating becomes inefficient, which may lead to an increase in the amount of communication.

In order to solve this problem, for example, a method has been devised in which a plurality of client apparatuses existing in a certain local area exchange evaluation values (for example, values representing quality of local data, computational capability, and the like) of the client apparatuses, and the client apparatuses whose evaluation values are higher than a predetermined value participate in the association learning.

However, this method causes a problem that the server device cannot control the number of client devices participating in the federation learning. For example, in the above-described example, since the number of client devices extracted for each local area is indefinite, the calculation capability may be excessively insufficient. The information processing method according to the present disclosure solves such a problem.

An information processing method according to a first aspect of the present disclosure includes: each of a plurality of information processing apparatuses mounted on a different mobile body performs machine learning using local data, and generates a local model, each of the plurality of information processing apparatuses receives a first threshold value and an evaluation index from a server device, each of the plurality of information processing apparatuses calculates an evaluation value according to the evaluation index, each of the plurality of information processing apparatuses is mounted on each of one or more other mobile bodies existing within a predetermined range by proximity communication, and the evaluation value is exchanged. The information processing apparatus includes a number of information processing apparatuses mounted on each of one or more mobile bodies existing within the predetermined range and having the calculated evaluation value equal to or larger than a predetermined value, and the number of information processing apparatuses having the first threshold value as an upper limit transmits local model information indicating the generated local model to the server device.

In the information processing method according to the first aspect of the present disclosure, among the plurality of information processing apparatuses, which apparatus participates in the federation learning is determined based on an evaluation value exchanged between the information processing apparatuses by the proximity communication. As a result, it is possible to select an information processing apparatus that participates in the federation learning from among a plurality of information processing apparatuses that are respectively mounted on mobile bodies that exist in a geographically close range. Note that “exchange” is not necessarily performed by unicast communication. For example, a mode in which the evaluation values are transmitted and received from each other by broadcast is also included. However, in such a system, for example, when an information processing apparatus is selected based on a criterion such as “the highest evaluation value”, only one information processing apparatus is selected within a predetermined range. On the other hand, if the information processing apparatus is selected based on a criterion such as “the evaluation value is higher than the predetermined value”, it is possible that more information processing apparatuses are selected than expected.

Therefore, in the information processing method according to the present aspect, the server device distributes the first threshold value to the plurality of information processing apparatuses in addition to the evaluation index for performing the evaluation. The first threshold is a value indicating the maximum number of information processing apparatuses selected within a predetermined range. Each of the plurality of information processing apparatuses determines whether or not the own apparatus transmits the local model information (that is, whether or not to participate in the association learning) within a predetermined range within a range in which the number of information processing apparatuses that transmit the local model information does not exceed the first threshold value. For example, each of the information processing apparatuses may determine that the own apparatus participates in the association learning in a case where a condition that (1) the evaluation value calculated by the own apparatus is equal to or greater than a predetermined value, and (2) the number of the information processing apparatuses that calculated the evaluation value higher than the own apparatus within the predetermined range is less than the first threshold value is satisfied.

According to such a configuration, in a system in which federated learning is performed by a plurality of client devices, the server device can control the number of client devices participating and the requirements to be satisfied by the client device. Accordingly, it is possible to improve the efficiency of the federation learning performed by the server device.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

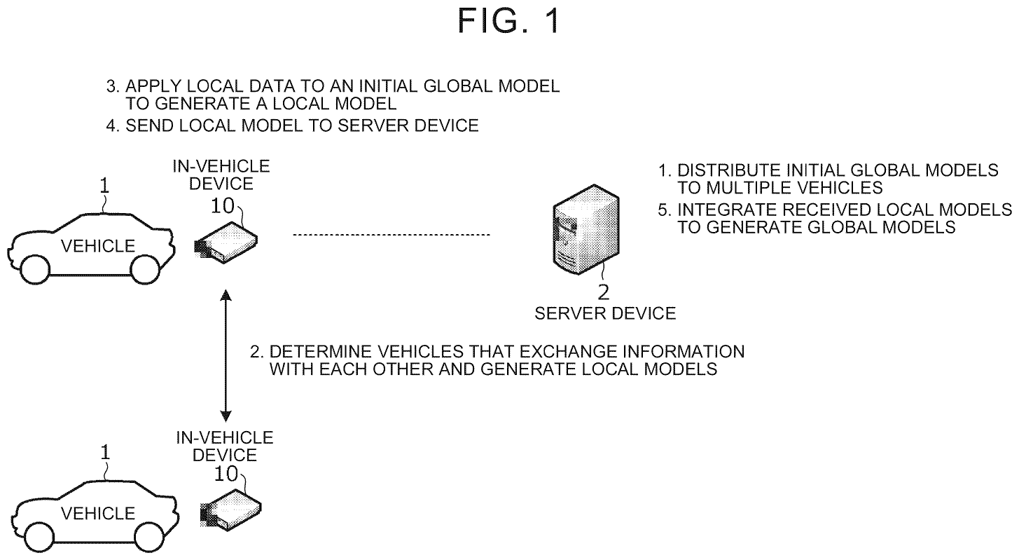

An outline of the system according to the present embodiment will be described. FIG. 1 is a diagram for explaining an outline of a federation learning system according to the present embodiment. The joint learning system according to the present embodiment includes a server device 2 and a plurality of in-vehicle devices 10 mounted on the plurality of vehicles 1.

The vehicle 1 is a connected vehicle capable of communicating with the server device 2 via wireless communication. The vehicle 1 can provide various services by communicating with an external server device via the in-vehicle device 10 having a wireless communication function. In the present embodiment, the in-vehicle device 10 has a function of training the machine learning model based on an instruction from the server device 2, and transmitting the machine learning model obtained as a result to the server device 2.

In the present embodiment, a model generated by the in-vehicle device 10 is referred to as a local model, and data used by the in-vehicle device 10 for learning (for example, sensor data collected by the vehicle 1) is referred to as local data. The in-vehicle device 10 generates a local model using the local data collected by the vehicle 1.

The server device 2 is one or more computers configured to acquire a local model from the in-vehicle device 10 and integrate the acquired local model. The server device 2 distributes a global model, which is a machine learning model in an initial state for generating a local model, to the plurality of in-vehicle devices 10. The in-vehicle device 10 performs machine learning of the global model using the collected local data, and generates a local model. The local model is a trained machine learning model after localization.

The in-vehicle devices 10 mounted on the plurality of vehicles located in the vicinity of each other communicate with each other to determine a vehicle for generating a local model. Each in-vehicle device 10 calculates an evaluation value according to a predetermined evaluation index acquired from the server device 2. Each in-vehicle device 10 transmits the calculated evaluation value to another in-vehicle device 10 mounted on each of one or more other vehicles existing in the vicinity of its own vehicle by near-field communication. Further, each in-vehicle device 10 receives an evaluation value calculated by the other in-vehicle device 10 from another in-vehicle device 10 mounted on each of one or more other vehicles existing in the vicinity of its own vehicle by close proximity communication. That is, the plurality of in-vehicle devices 10 within the predetermined range exchange the calculated evaluation values with each other.

Each in-vehicle device 10 determines, for example, whether or not the in-vehicle device is a device that transmits a local model to the server device 2 (that is, whether or not to participate in association learning), based on the evaluation value calculated by the in-vehicle device and the evaluation value received from the other in-vehicle device 10.

The server device 2 receives local model information indicating a local model from at least one of the plurality of in-vehicle devices 10. In addition, the server device 2 integrates the local model indicated by the local model information received from each of the at least one in-vehicle device 10. Accordingly, the server device 2 generates a new global model. The new global model is a trained machine learning model generated by integrating the local models obtained from the at least one in-vehicle device 10.

### Device Configuration

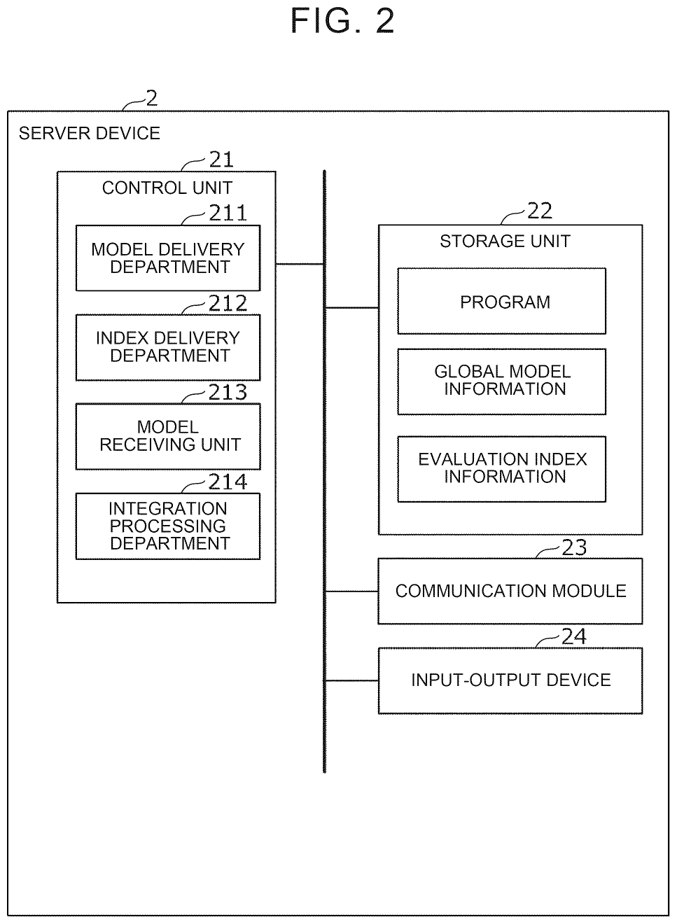

FIG. 2 is a diagram illustrating an example of a configuration of the server device 2. The server device 2 is, for example, a computer such as a personal computer, a smartphone, a mobile phone, a tablet computer, or a personal information terminal. The server device 2 includes a control unit 21, a storage unit 22, a communication module 23, and an input/output device 24.

The server device 2 can be configured as a computer including a processor (such as a CPU, GPU), a main storage device (such as a RAM, ROM), and an auxiliary storage device (such as a EPROM, a hard disk drive, and a removable medium). The secondary storage device stores an operating system (OS), various programs, various tables, and the like, and by executing the programs stored therein, it is possible to realize functions (software modules) that meet predetermined objectives, as will be described later. However, some or all of the functions may be realized as a hardware module by, for example, hardware circuitry such as an ASIC, FPGA.

The control unit 21 is an arithmetic unit that realizes various functions of the server device 2 by executing a predetermined program. The control unit 21 can be realized by, for example, a hardware processor such as a CPU. In addition, the control unit 21 may be configured to include a RAM, Read Only Memory (ROM), a cache memory, and the like.

The control unit 21 includes four software modules: a model distribution unit 211, an index distribution unit 212, a model receiving unit 213, and an integration processing unit 214. The software modules may be realized by executing programs stored in the storage unit 22 (described later) by the control unit 21 (CPU).

The model distribution unit 211 is configured to transmit global model information indicating a global model to each of the plurality of in-vehicle devices 10. The global model may be a machine learning model in an initial state before learning, or may be a machine learning model after learning.

The index distribution unit 212 is configured to transmit evaluation index information indicating the evaluation index to each of the plurality of in-vehicle devices 10. In the present embodiment, the global model and the evaluation index are distributed from the server device 2 to each in-vehicle device 10 by the operations of the model distribution unit 211 and the index distribution unit 212. Details of the evaluation index will be described later.

The model receiving unit 213 is configured to receive local model information indicating a local model from at least one of the plurality of in-vehicle devices 10. The in-vehicle device is an in-vehicle device that has determined that “its own device transmits a local model to the server device 2” as a result of the selection process based on the evaluation value. Details of the selection process based on the evaluation value will be described later.

The integration processing unit 214 is configured to integrate the local model indicated by the local model information received from the at least one in-vehicle device 10, and generate a new global model. The integration processing unit 214 may be further configured to generate global model information indicating a new global model obtained by integration, and store the generated global model information in a predetermined storage area (for example, the storage unit 22).

The storage unit 22 is a means for storing information, and is composed of a storage medium such as a RAM, a magnetic disk, or a flash memory. The storage unit 22 stores a program executed by the control unit 21, data used by the program, and the like.

The storage unit 22 stores the above-described global model information and evaluation index information. The global model information includes a global model distributed to the in-vehicle device 10. The global model distributed to the in-vehicle device 10 may be a machine learning model (in an initial state) before learning, or may be a machine learning model after learning.

The evaluation index information includes an evaluation index to be distributed to the in-vehicle device 10. The evaluation index is an index for selecting the in-vehicle device 10 participating in the federation learning. The evaluation index may include a mathematical expression or the like for calculating an evaluation value. The evaluation value is an evaluation value for selecting the in-vehicle device 10 that generates a local model suitable for updating the global model (that is, the performance of the new global model generated by the integration becomes better). The evaluation index includes, for example, a mathematical expression for evaluating the quality of the local data, a mathematical expression for evaluating the computational capability, a mathematical expression for evaluating the communication capability, and the like. By calculating the evaluation value by the in-vehicle device 10 according to these mathematical expressions, it is possible to determine “which device among the plurality of in-vehicle devices within a predetermined range participates in the association learning”. Further, the evaluation index information includes a threshold value of an evaluation value (hereinafter, “evaluation threshold value”). The evaluation threshold value is a threshold value for filtering the in-vehicle device 10 to participate in the federation learning. In the present embodiment, the in-vehicle device 10 in which the evaluation value calculated according to the evaluation index exceeds the evaluation threshold value participates in the association learning. Further, the evaluation index information includes information (hereinafter, referred to as “number information”) specifying the maximum number of in-vehicle devices 10 participating in the joint learning within a predetermined range (hereinafter, referred to as “number of participating devices”).

The communication module 23 is a wireless communication interface for connecting the server device 2 to a network. The communication module 23 is configured to be able to communicate with a plurality of in-vehicle devices 10 via a mobile body communication service such as a radio LAN, a 3G, 4G, or a 5G.

The input/output device 24 is a unit that receives an input operation performed by an operator and presents information. Specifically, the input/output device 24 includes a device for inputting a mouse, a keyboard, or the like, and a device for outputting a display, a speaker, or the like. The input/output device may be integrally formed of, for example, a touch panel display or the like.

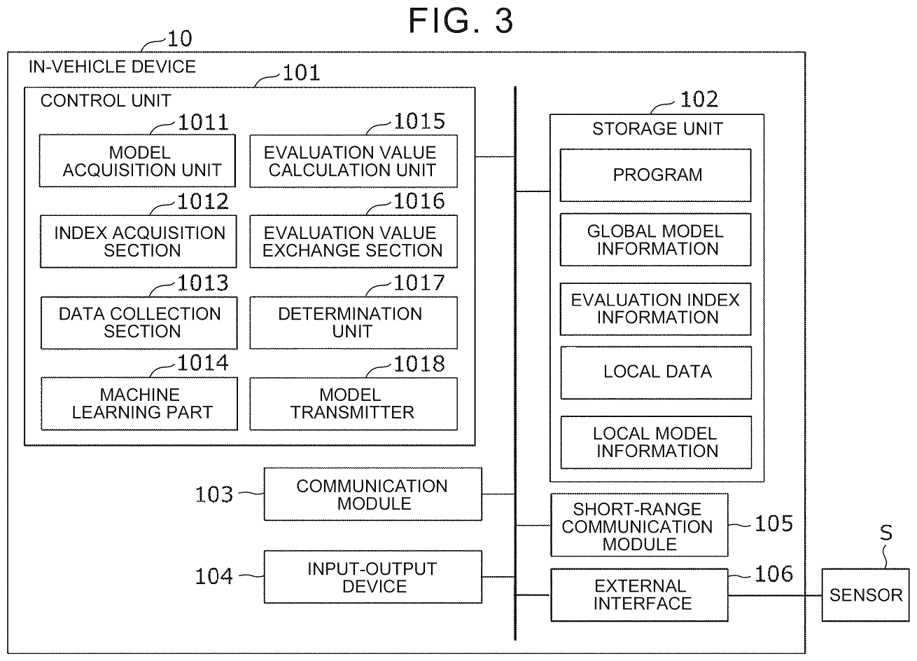

FIG. 3 is a diagram illustrating an example of a configuration of the in-vehicle device 10. The in-vehicle device 10 is, for example, a computer such as a personal computer, a smartphone, a mobile phone, a tablet computer, or a personal information terminal. The in-vehicle device 10 includes a control unit 101, a storage unit 102, a communication module 103, an input/output device 104, a short-range communication module 105, and an external interface 106.

The in-vehicle device 10 can be configured as a computer including a processor (such as a CPU, GPU), a main storage device (such as a RAM, ROM), and an auxiliary storage device (such as a EPROM, a hard disk drive, and a removable medium).

The control unit 101 is an arithmetic unit that realizes various functions of the in-vehicle device 10 by executing a predetermined program. The control unit 101 can be realized by, for example, a hardware processor such as a CPU. In addition, the control unit 101 may be configured to include a RAM, Read Only Memory (ROM), a cache memory, and the like.

The control unit 101 includes eight software modules including a model acquisition unit 1011, an index acquisition unit 1012, a data collection unit 1013, a machine learning unit 1014, an evaluation value calculation unit 1015, an evaluation value exchange unit 1016, a determination unit 1017, and a model transmission unit 1018. The respective software modules may be realized by executing programs stored in the storage unit 102, which will be described later, by the control unit 21 (CPU).

The model acquisition unit 1011 is configured to acquire global model information indicating a global model from the server device 2. In the present embodiment, the model acquisition unit 1011 is configured to receive global model information distributed from the server device 2. The index acquisition unit 1012 is configured to acquire evaluation index information indicating the evaluation index from the server device 2. As described above, the evaluation index information includes three pieces of information: (1) an index (evaluation index) for calculating the evaluation value; (2) a threshold value of the evaluation value; and (3) the maximum number of in-vehicle devices 10 participating in the association learning within a predetermined range (the number of participating devices).

The data collection unit 1013 is configured to collect local data acquired by one or more sensors included in the vehicle 1. The machine learning unit 1014 is configured to perform machine learning of a global model and generate a local model using the collected local data. The machine learning unit 1014 may be further configured to store the generated local model information in a predetermined storage area.

The evaluation value calculation unit 1015 is configured to calculate an evaluation value according to the evaluation index included in the evaluation index information acquired from the server device 2. The evaluation value exchange unit 1016 is configured to exchange the calculated evaluation value with another in-vehicle device 10 mounted on each of one or more other vehicles existing in the vicinity of its own vehicle by near-field communication. In the present embodiment, a range in which near-field communication is possible is a “predetermined range”.

The determination unit 1017 executes a process of determining “whether or not the own device operates as a device that generates a local model and transmits the local model to the server device 2” based on the evaluation index information received from the server device 2 and the result of exchanging the evaluation values with the other in-vehicle devices 10. In the following description, the determination of the in-vehicle device 10 that generates a local model and transmits the local model to the server device 2 from among the plurality of in-vehicle devices 10 within a predetermined range is referred to as “selection”, and the processing for this purpose is referred to as “selection processing”. In other words, the selected in-vehicle device 10 is a device that participates in the federation learning. In the present embodiment, each of the plurality of in-vehicle devices 10 executes a selection process, and the own device autonomously and decentrally determines whether or not to participate in the federation learning. The model transmission unit 1018 is configured to transmit local model information indicating the generated local model to the server device 2 based on the result of the determination performed by the determination unit 1017.

The storage unit 102 is means for storing information, and is composed of a storage medium such as a RAM, a magnetic disk, or a flash memory. The storage unit 102 stores programs executed by the control unit 101, data used by the programs, and the like.

The storage unit 102 stores global model information and evaluation index information received from the server device 2. The global model information is used for generating the local model information, and the evaluation index information is used for the determination performed by the determination unit 1017. Further, the storage unit 102 stores local data and local model information. The local data is data collected by a sensor S to be described later. The local model information includes a local model generated by the machine learning unit 1014.

The communication module 103 is a wireless communication interface for connecting the in-vehicle device 10 to a network. The communication module 103 is configured to be able to communicate with the server device 2 via a mobile body communication service such as a radio LAN, a 3G, 4G, or a 5G.

The input/output device 104 is a unit that receives an input operation performed by an occupant of the vehicle and presents information to the occupant. Specifically, the input/output device 104 includes a device for inputting a mouse, a keyboard, or the like, and a device for outputting a display, a speaker, or the like. The input/output device may be integrally formed of, for example, a touch panel display or the like.

The short-range communication module 105 is a communication module for transmitting and receiving data by near field communication. In one example, the short-range communication module 105 may be a beacon module. The type of the beacon module may be appropriately selected according to the embodiment. A beacon module of a known type may be employed as the short-range communication module 105. In the present embodiment, the short-range communication module 105 is used to perform near field communication with other in-vehicle devices 10 other than the own device. Note that the type of the short-range communication module 105 is not limited to the beacon module. In another embodiment, the short-range communication module 105 may be configured to be capable of performing near field communication such as Wi-Fi (registered trademark), Bluetooth (registered trademark), D2D, etc.

The external interface 106 is an interface for connecting to an external device, such as a Universal Serial Bus (USB) port or a dedicated port. The type and number of the external interfaces 106 may be appropriately determined according to the type and number of the external devices to be connected. In the present embodiment, the in-vehicle device 10 is connected to the sensor S via the external interface 106. The sensor S may be constituted by a plurality of sensors such as an imaging sensor (camera, etc.), a proximity sensor, a light detection and ranging (Lidar) sensor, and a Radar, for example.

Note that specific hardware configurations of the in-vehicle device 10 and the server device 2 can be omitted, replaced, or added as appropriate depending on the embodiment. For example, the control unit 101 and the control unit 21 may include a plurality of hardware processors. The hardware processor may be composed of a microprocessor, a FPGA, GPU, or the like. Further, an input/output device (for example, an optical drive or the like) other than those exemplified may be added. In addition, the server device 2 may be configured by a plurality of computers. In this case, the hardware configurations of the computers may or may not be identical.

### Processing Flow

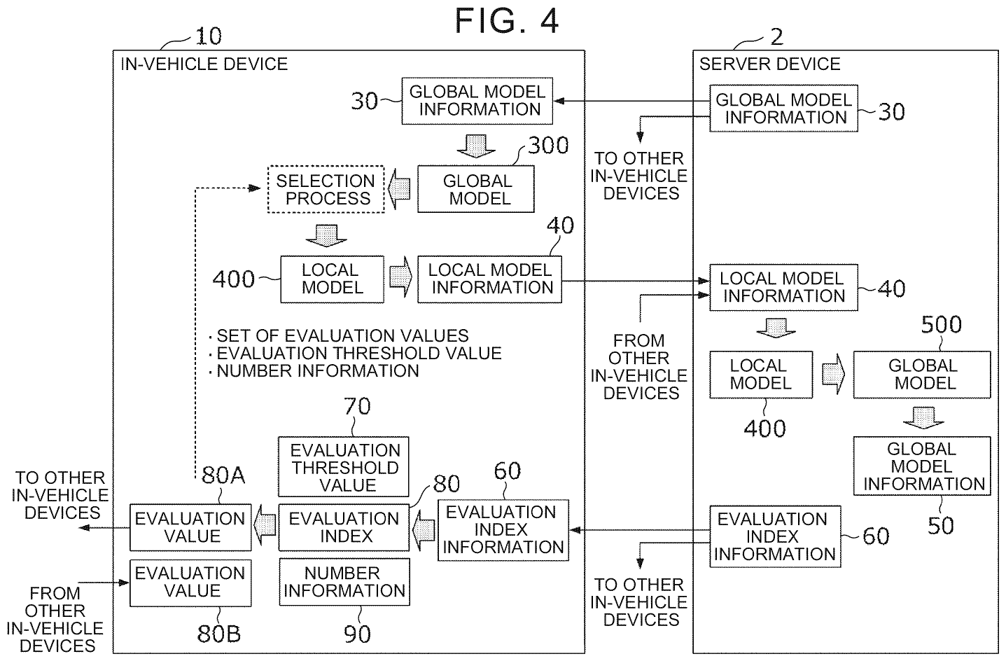

Next, a flow of data transmitted and received between apparatuses will be described with reference to FIG. 4. FIG. 4 is a diagram illustrating a flow of data transmitted and received by each element of the server device 2 and the in-vehicle device 10.

First, the server device 2 (model distribution unit 211) transmits global model information 30 indicating the global model 300 to each of the plurality of in-vehicle devices 10. The global model 300 may be a machine learning model in an initial state before learning. The in-vehicle device 10 (model acquisition unit 1011) receives the global model information 30 and extracts the global model 300 from the global model information 30.

Further, the server device 2 (the index distribution unit 212) transmits the evaluation index information 60 to each of the plurality of in-vehicle devices 10. The in-vehicle device 10 (index acquisition unit 1012) receives the evaluation index information 60 from the server device 2, and acquires the evaluation index 80, the evaluation threshold value 70, and the number information 90 included in the evaluation index information 60.

The in-vehicle device 10 (evaluation value calculation unit 1015) calculates an evaluation value according to the evaluation index 80. The evaluation index 80 is appropriately defined so that the in-vehicle device 10 that generates the local model 400 suitable for updating the global model 300 (that is, such that the performance of the new global model obtained as a result of the federation learning becomes better) is selected. The quality of the local data affects the accuracy of the new global model generated by the federated learning. Further, the higher the calculation capability of the in-vehicle device 10, the faster the local model 400 can be created, and the shorter the time required for aggregating the local model 400 in the server device 2 can be achieved. Similarly, the higher the communication capability of the in-vehicle device 10, the shorter the time for aggregating the local model 400 in the server device 2 can be. Therefore, in the present embodiment, at least one of the first index for evaluating the quality of the local data, the second index for evaluating the calculation capability of each in-vehicle device 10, and the third index for evaluating the communication capability of each in-vehicle device 10 is included in the evaluation index 80. The evaluation index 80 may be represented by a function. In this case, each in-vehicle device 10 calculates an evaluation value by executing arithmetic processing of a function representing the evaluation index 80.

The first index may be an index that is defined such that the evaluation becomes higher as the local data is beneficial for improving the performance of the global model 300, and the evaluation becomes lower as the local data is not beneficial for improving the performance. Whether local data is beneficial may be evaluated using the global model 300. For example, an objective function used for machine learning of the global model 300 may be used to evaluate the benefit of the local data. For example, in a case where the optimization problem in machine learning is achieved by minimizing the value of the objective function, the first index may be defined such that the evaluation is higher as the error calculated by the objective function is larger by giving the local data to the global model 300, and the evaluation is lower as the error is smaller.

The second index may be an index defined such that the higher the calculation capability, the higher the evaluation, and the lower the calculation capability, the lower the evaluation. The second indicator may be represented by a function. The computational capability may be calculated according to the performance of computational resources, such as processor resources, memory resources, etc. The computational capability may be evaluated based on, for example, a computational speed of the processor resources, a capacity of the memory resources, a read speed of the memory resources, and the like.

The third index may be an index defined such that the higher the communication capability, the higher the evaluation, and the lower the communication capability, the lower the evaluation. The third indicator may be represented by a function. The communication capability may be calculated according to the performance of a communication module that may be used to transmit the local model 400. The communication capability may be evaluated based on, for example, a bandwidth, a communication speed, and the like of the communication.

In a case where the evaluation index 80 includes the first index, the second index, and the third index, the evaluation index 80 may be configured by an expression obtained by combining the above-described functions. In the following explanation, the evaluation value calculated by the in-vehicle device 10 (the evaluation value calculation unit 1015) using the evaluation index 80 is referred to as an evaluation value 80A. The calculated evaluation value 80A is broadcast transmitted by the in-vehicle device 10 (evaluation value exchanging unit 1016) to another vehicle (another in-vehicle device 10) located in the vicinity of the vehicle 1 (within a predetermined range centered on the vehicle 1).

Further, the in-vehicle device 10 (evaluation value exchanging unit 1016) receives an evaluation value (hereinafter referred to as evaluation value 80B) calculated by another in-vehicle device 10. There may be a plurality of other vehicles 1 and other in-vehicle devices 10. Here, there may be a plurality of evaluation-value 80B. Accordingly, the vehicle 1 (the in-vehicle device 10) located within the predetermined range can obtain a plurality of sets of evaluation values corresponding to all the vehicles located within the predetermined range.

The in-vehicle device 10 performs a selection process using the acquired set of evaluation values, the evaluation threshold value, and number information. Specifically, the in-vehicle device 10 determines that its own device is selected when the following conditions are satisfied.
(1) The calculated evaluation value 80A exceeds the evaluation threshold value.
(2) The number of vehicles 1 which calculated an evaluation value higher than that of the own device in a predetermined area is lower than the number of participating vehicles indicated by the number information.
For example, in a case where five evaluation values are included in the set of evaluation values obtained by replacement, the evaluation values calculated by the host vehicle (satisfying the evaluation threshold value) are the third highest and the number of participating vehicles indicated by the number information is three, the above-described conditions are satisfied, and thus the vehicle is selected.

When the vehicle is selected, the in-vehicle device 10 generates the local model 400 based on the global model 300. The machine learning unit 1014 generates learning data based on the local data and applies the generated learning data to the global model 300 to perform machine learning. The local data is composed of a plurality of data sets. Each data set is composed of a combination of training data and correct labels and is used as a sample of a training target in machine learning. The training data is a sample of explanatory variables and is input to the machine learning model in machine learning. If the inference task is to derive an inference result from the sensor data, the training data may be sensor data obtained by the sensor S. The correct answer label is configured to indicate the true value of the target variable for the sample of the entered explanatory variable, i.e., the solution (true value) of the inference task for the corresponding training data. In machine learning, training data is used as input data and correct answer labels are used as teacher data.

For each data set, the machine learning unit 1014 trains the global model 300 so that the output value (inference result) obtained from the global model 300 matches the true value indicated by the correct answer label by providing the training data. Training the global model 300 is configured by adjusting (optimizing) the values of the computational parameters that make up the global model 300. The adjustment method of the calculation parameter (the method of solving the optimization problem) may be appropriately determined according to the type, configuration, structure, and the like of the machine learning model to be adopted in the global model 300.

The machine learning unit 1014 adjusts the value of the calculation parameter of the global model so that the sum of the error between the output value (inference result) obtained by giving the training data and the true value indicated by the correct answer label is reduced by the series of update processing. The adjustment of the value of the calculation parameter may be repeated until a predetermined condition is satisfied, for example, the adjustment of the set number of iterations is performed, the sum of the calculated errors becomes equal to or less than a threshold value, or the like. Further, for example, the conditions of machine learning such as an objective function (a cost function, a loss function, an error function) for calculating an error, and a learning rate may be appropriately set according to the embodiment. By the processing of the machine learning, the local model 400 can be generated. The machine learning unit 1014 generates local model information 40 indicating the local model 400.

Note that the method of machine learning is not limited to supervised learning. In another example, unsupervised learning (including hostile learning) or reinforcement learning may be employed as the machine learning approach. The configuration of the local data may be appropriately determined in accordance with a method of machine learning to be adopted, a type of machine learning model, and the like. The machine learning model constituting the global model 300 may be a neural network, a regression model, a support vector machine, or the like. The generated local model information 40 is transmitted to the server device 2.

The server device 2 (the integration processing unit 214) generates a new global model 500 by integrating the local model 400 indicated by the local model information 40 received from the at least one in-vehicle device 10. The integration of the plurality of local models 400 may be performed by averaging the values of the corresponding operation parameters included in each local model 400, summing the values of the corresponding operation parameters, and the like. The values of the calculation parameters included in each local model 400 may be weighted and then integrated. In this case, the weight of each local model 400 may be specified in any manner.

Integration of the local model 400 may be performed for all computational parameters or for some computational parameters. In a case where the integration of the local model 400 is partially performed, the information of the range in which the integration is not performed may be omitted in the local model information 40 transmitted from the in-vehicle device 10 to the server device 2. The server device 2 (the integration processing unit 214) generates global model information 50 indicating the new global model 500. The configuration of the global model information 50 may be the same as that of the global model information 30.

### Flowchart

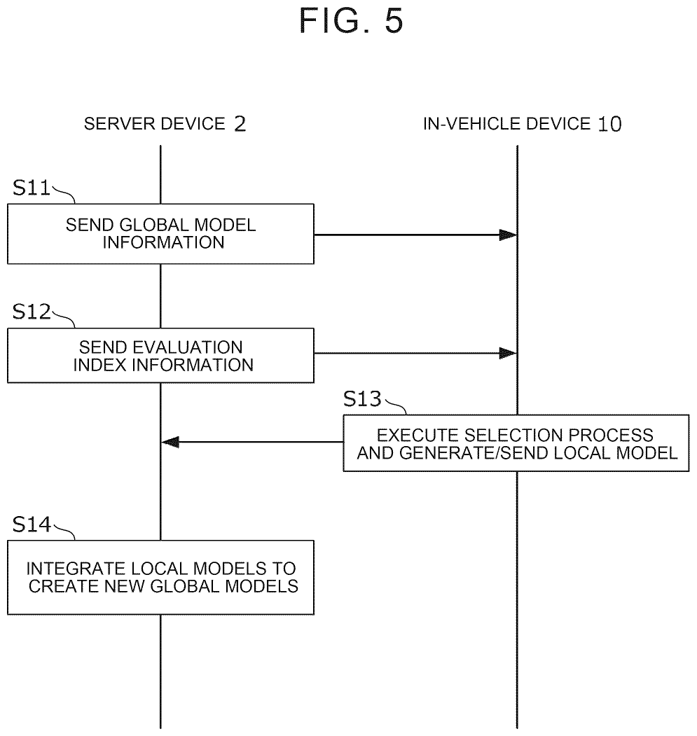

FIG. 5 is a sequence diagram illustrating an example of a process of the association learning executed between the server device 2 and each in-vehicle device 10 according to the present embodiment.

First, in S11, the control unit 21 (model distribution unit 211) of the server device 2 uses the communication module 23 to transmit the global model information 30 indicating the global model 300 to the in-vehicle devices 10. The transmission may be performed, for example, by broadcast. In addition, in a case where a geographical range for integrating the local models 400 is defined, the global model 300 to be distributed for each defined range may be selected.

The global model 300 may be a pre-training machine learning model or a trained machine learning model. In a case where the global model 300 is a trained machine learning model, the global model 300 may be generated by machine learning by the server device 2 or may be generated by an integration process by prior federation learning. The global model information 30 is received by the in-vehicle device 10 (the model acquisition unit 1011).

In S12, the control unit 21 (index distribution unit 212) of the server device 2 uses the communication module 23 to transmit the evaluation index information 60 including the evaluation index 80, the evaluation threshold value 70, and the number information 90 to the in-vehicle devices 10.

Similar to S11, the transmission range and the transmission method can be appropriately selected according to the embodiment. As an example, the control unit 21 may transmit the evaluation index information 60 to each in-vehicle device 10 by broadcast. Accordingly, the bandwidth of the wireless communication can be saved. Further, the evaluation index 80 to be distributed may be selected for each geographical range. In this case, the evaluation index 80 to be partially distributed may be different from the evaluation index 80 to be otherwise distributed.

In S13, the in-vehicle devices 10 execute an autonomous distributed vehicle selection process, and when the in-vehicle devices are selected, generate a local model and transmit the local model to the server device 2.

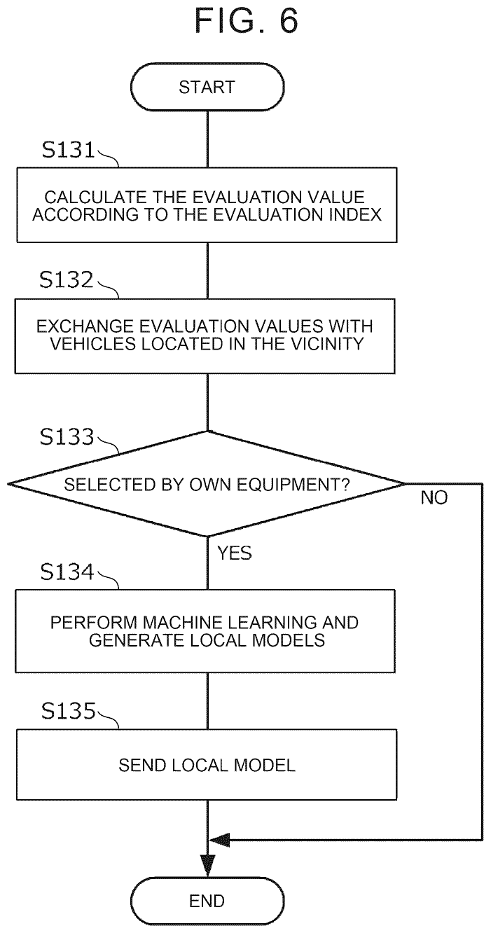

FIG. 6 is a flow chart illustrating an exemplary process executed by the in-vehicle device 10 in S13. The process of S13 according to the present embodiment includes the process of S135 from S131 described below.

In parallel with the illustrated processing, the control unit 101 (data collection unit 1013) of the in-vehicle device 10 collects the local data generated by the sensor S and stores the collected local data in the storage unit 102.

In S131, the control unit 101 (evaluation value calculation unit 1015) calculates an evaluation value of the own device according to the evaluation index 80 indicated by the received evaluation index information 60. In S132, the control unit 101 (evaluation value exchanging unit 1016) transmits the evaluation value calculated by the own device to another in-vehicle device 10 mounted on each of one or more other vehicles existing in the vicinity of the own vehicle by near-field communication. Further, the evaluation value calculated by the other in-vehicle device 10 according to the evaluation index 80 is received from the other in-vehicle device 10 mounted on each of the other vehicles. Note that the timing at which the transmission and reception of the evaluation values are executed may be adjusted between the in-vehicle devices 10 by an arbitrary method. The short-range communication module 105 is used for the near field communication. In the present embodiment, each in-vehicle device 10 uses a beacon module as the short-range communication module 105. When the replacement of the valuation is completed, the process transitions to S133.

In S133, the control unit 101 (the determination unit 1017) determines whether or not the host vehicle is a selection target based on the evaluation value exchanged with the nearby vehicle. In this step, an affirmative determination is made when both of (1) the calculated evaluation value exceeds the evaluation threshold value and (2) the number of vehicles in which the evaluation value higher than the own apparatus is calculated within a predetermined range is less than the number of participating vehicles indicated by the number information.

If an affirmative determination is made on S133, the process proceeds to S134. In S134, the control unit 101 (the machine learning unit 1014) generates the local model 400 by performing machine learning of the received global model 300 using the collected and accumulated local data.

In S135, the control unit 101 (the model transmitting unit 1018) transmits the local model information 40 indicating the generated local model 400 to the server device 2. The server device 2 (model receiving unit 213) receives the local model information 40 transmitted from the in-vehicle device 10. When the transmission of the local model information 40 is completed, the control unit 101 of the in-vehicle device 10 ends the processing procedure according to this operation example.

Returning to FIG. 5, the description will be continued. In S14, the control unit 21 (the model receiving unit 213) of the server device 2 generates a new global model 500 by integrating the local model 400 indicated by the local model information 40 received from the at least one in-vehicle device 10.

When the generation of the new global model 500 is completed, the control unit 21 of the server device 2 ends the processing procedure according to this operation example. Note that the server device 2 and the respective in-vehicle devices 10 may treat the new global model 500 as the global model 300 and repeatedly execute the process of the association study from S11.

As described above, the server device 2 according to the present embodiment provides the evaluation index information including the evaluation index, the evaluation threshold value, and the number information to the plurality of vehicles that are candidates to participate in the federation learning. The vehicle that has received the evaluation index information executes the selection process, and the number of vehicles that set the number specified by the server device 2 as the upper limit responds. According to this configuration, it is possible to control the number of vehicles participating in the federation learning by the server device.

### Modified Examples

The above-described embodiments are merely examples, and the present disclosure may be appropriately modified and implemented without departing from the scope thereof. For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing method comprising:
each of a plurality of information processing apparatuses mounted on different mobile bodies generating a local model by performing machine learning using local data;
each of the information processing apparatuses receiving a first threshold value and an evaluation index from a server device;
each of the information processing apparatuses calculating an evaluation value according to the evaluation index;
each of the information processing apparatuses exchanging the evaluation value with another information processing apparatus mounted on each of one or more other mobile bodies existing within a predetermined range through near field communication; and
a number of information processing apparatuses transmitting local model information that indicates the generated local model to the server device, the information processing apparatuses being mounted on respective ones of one or more mobile bodies existing within the predetermined range and having calculated an evaluation value that is equal to or more than a predetermined value, and the number of the information processing apparatuses being up to the first threshold value.

2. The information processing method according to claim 1, wherein the evaluation index includes an index for evaluating at least one of a quality of the local data, an arithmetic capability of the information processing apparatus, and a communication capability of the information processing apparatus.

3. The information processing method according to claim 1, wherein:
the server device transmits a global model to each of the information processing apparatuses; and
each of the information processing apparatuses generates the local model based on the global model.

4. The information processing method according to claim 1, wherein each of the information processing apparatuses determines whether to transmit the local model information to the server device based on a plurality of exchanged evaluation values.

5. The information processing method according to claim 4, wherein each of the information processing apparatuses transmits the local model information to the server device when the evaluation value calculated by the apparatus itself is equal to or more than the predetermined value and the number of the information processing apparatuses existing within the predetermined range and having calculated an evaluation value that is more than that calculated by the apparatus itself is less than the first threshold value.
